(19) United States
(12) Patent Application Publication
(10) Pub. No.: US 2005/0265172 A1
(43) Pub. Date: Dec. 1, 2005

(54) Multi-channel audio/video system and authoring standard

(75) Inventors: James Stankiewicz, Vero Beach, FL (US); Stephen B. Livingstone, Palm City, FL (US)

Correspondence Address: LERNER AND GREENBERG, PA, P O BOX 2480, HOLLYWOOD, FL, 33022-2480, US

(73) Assignee: Star Sessions, LLC

(21) Appl. No.: 11/138,237

(22) Filed: May 25, 2005

Related U.S. Application Data
(60) Provisional application No. 60/574,814, filed on May 26, 2004.

(51) Int. Cl. G11B 5/09

(52) U.S. Cl. 369/47.16; 369/47.15; 369/47.1; 369/89

(57) ABSTRACT

A multimedia format for karaoke includes a first channel featuring a first performance of a song that is playable through a first speaker, a second channel featuring a synchronized second performance of the song that is playable through a second speaker, and a video channel featuring music information of a performance to accompany the channels to complete the song. Musicians, not just vocalists, may perform with the other tracks of a song to complete it. The multimedia format can be placed on DVD or similar media and played through the separate channels of a surround sound home theater. Alternatively, dedicated systems for playing the media are also included.

### CROSS-REFERENCE TO RELATED APPLICATION

This application claims the benefit, under 35 U.S.C. § 119(e), of provisional application No. 60/574,814, filed May 26, 2004; which is herewith incorporated by reference in its entirety.

### BACKGROUND OF THE INVENTION

1. Field of Invention

The present invention relates to a multi-channel audio and video multimedia system. More specifically, the invention pertains to a multi-instrument karaoke-type system with associated media and a corresponding authoring standard. The invention further relates to an authoring standard for multi-instrument audio playback in a variety of existing and new media formats.

Although the invention is not a Karaoke system in its pure sense, it will be best understood with reference to such a prior art system.

2. Description of the Related Art

Karaoke as an entertainment platform has existed for many years. It is most often used as a source of entertainment that allows people of varying musical abilities to accompany recognizable music tracks. The music tracks are compiled by content providers and supplied in a range of media utilizing specific karaoke hardware.

The vocal track is either damped or muted during the performance. This allows a live “substitute” person to sing the lyric in sync and, hopefully, in tune with the music and with the common assistance of on-screen displayed lyrics in a chosen language. The words in the lyrics are individually highlighted to assist the performer with the timing of the song.

Karaoke is wildely popular in Japan and has become increasingly popular throughout the world. Millions now enjoy Karaoke in private settings or in clubs and restaurants. Karaoke is used to describe any sing-a-long track that displays lyrics on a display screen. Usually, a music disc includes vocals and accompaniment. Music discs, in which only the accompaniment is recorded, are referred to as Karaoke CDs or Karaoke Discs. A typical Karaoke system includes a CD player with the added function of video. The hardware thus allows the user to play the latest standard Karaoke CDG discs in the player and connect the player to a television (or a video monitor) to display the lyrics of the songs in real-time accompaniment.

The most widely used format for Karaoke applications is the CDG or CD+G format (“Compact Disc +Graphics”). The discs are substantially identical to standard CDs (compact discs) yet have the additional graphics track for display of the song lyrics on a connected TV or video monitor.

Conventional Karaoke systems substitute only the vocals of a song. It is virtually impossible to add non-original material other than voice during a performance. In addition, the systems and standards that have emerged rely on the need to purchase specific karaoke hardware in order to play back, control, and display the lyrics. No karaoke-type system addresses the needs of the non-vocal musicians, (i.e., guitarists, pianists, drummers, etc.) nor do they permit performers to play alongside the original artists themselves or utilize their original instrumental/vocal materials in which the playing and substitution of one and more instruments simultaneously is enabled using DVD and/or other media. In addition, no karaoke system permits multiple performers to contribute in parallel to the playback of a song by an original artist. In addition, no karaoke system currently allows the playback and performance of the art using an existing DVD player or permits several contributors to participate without the need to purchase dedicated hardware.

### SUMMARY OF THE INVENTION

It is accordingly an object of the invention to provide a multi-channel audio/video system and authoring standard which overcomes the above-mentioned disadvantages of the heretofore-known devices and methods of this general type and which provides for a more open system with multiple track management and multiple contribution by one or a plurality of performers. It is a further object of the invention to provide a karaoke-type system that will open up a new form of karaoke previously not available as a means of entertainment performance and education and training.

With the foregoing and other objects in view there is provided, in accordance with the invention, a multi-channel multimedia format, comprising:
a first channel carrying at least a first track of audio content of a given performance;
a second channel carrying a second track of audio content of the given performance in synchronicity with the first track; and
a third channel carrying video content related to the given performance and synchronized to the first and second tracks of audio content; and
wherein each of the first, second, and third channels is separately and independently selectable to be played through an output device.

In accordance with an added feature of the invention, the first and second channels carry discretely separate tracks of the given performance and are separately playable through a first speaker and a second speaker, respectively.

Preferably, the third channel carries video content selected from the group consisting of a music video, lyrics, tabular music, and sheet music.

In accordance with an additional feature of the invention, the first and second channels are two of at least five discrete digital channels. In a preferred embodiment of the invention, the digital channels are coded in a Dolby® Digital system or a DTS® system.

With the above and other objects in view there is also provided, in accordance with the invention, a digital media carrier for advanced karaoke, comprising:
audio content encoded in at least five discrete digital channels of a Dolby® or a DTS® system;
the at least five discrete digital channels containing up to five solo channels, each featuring individual tracks of an audio performance, and each being individually selectable and deselectable; and
a video channel featuring video display content related to the audio performance for display on a visual display.

Further, each of the five solo channels may be playable through a different speaker of the Dolby® or DTS® system, and an LFE channel is configured to multiplex up to five of the solo channels and to be played through headphones connected to the Dolby® or DTS® system.

As noted above, the video channel carries video content selected from the group consisting of lyrics, music video, music notation, tablature, and individual instrument sheet music, and the video content is synchronized with audio content.

With the above and other objects in view there is also provided, in accordance with the invention, a computer-readable medium having mutimedia content stored thereon, comprising:
audio content in an encoded format to be decoded into discrete channels for audio playback with a menu-driven option of selective elimination from the audio playback of at least one of the discrete channels; and
video content synchronized to the audio content for display on a video display during the audio playback.

The computer-readable medium, in other words, has a data structure stored thereon, with:
a first channel of audio content in an encoded format to be decoded into a plurality of discrete channels for audio playback with a menu-driven option of selective elimination from the audio playback of at least one of the discrete channels; and
a second channel of video content synchronized to the audio content for display on a video display during the audio playback.

With the above and other objects in view there is also provided, in accordance with the invention, a karaoke system, comprising:
a player for reading and processing the afore-mentioned computer-readable medium;
a mixer for selecting/deselecting and adjusting a volume of each audio channel of the audio content;
at least one audio amplifier connected to the player for playing back decoded audio content;
at least one audio playback device (speaker, headphone, recorder) connected to the audio amplifier; and
a video display for displaying the video content carried on the computer-readable medium.

Due to its wide availability and its considerable market penetration, the preferred discrete multi-channel system for the invention is Dolby® Digital 5.1. Tens of millions of households worldwide have Dolby Digital 5.1 home receivers, and many digital cable, satellite, and terrestrial DTV set-top boxes encode data to deliver a Dolby Digital 5.1 audio stream. As the number of Dolby Digital 5.1-channel devices continues to rise, more television services are broadcasting in Dolby Digital 5.1 sound, delivering an increasing variety of high-quality programming to their viewers.

In view of the foregoing disadvantages inherent in the known types of karaoke now present in the prior art, the present invention provides a new form of multi-channel selectivity in audio, video, and mixed multimedia applications. The invention uses original artists' material in the compilation of the content. This includes not only the voice, but also the musical instruments that are used to create the track are also individually separated using a system of digital encoding that is employed when the media is originally authored at the recording studio.

Those of skill in the art of audio recording technology understand that most popular music and a considerable book of classical music has for decades been recorded in multitrack technology. That is, virtually all original recordings are available on a multichannel master recording, typically in 8-track (1 950's), 16-track (1960's), 32 and 36-track (1970's), or 64 and 72-track magnetic tape. In studio recordings, the channel separation between the individual tracks is virtually perfect and cross-talk between channels (i.e., between tracks) is non-existent or it is negligible in most contexts. Where channel separation is maintained from the original master to the final output medium—as in the instant invention—the individual channels or tracks are still completely separated. In live recordings, the quality of channel separation depends on the recording. Depending on the number of distributed microphones and the directionality of the microphones used in the recording, the channel separation may still reach a level that renders crosstalk between tracks nearly unnoticeable. Such live recordings, then, are still available for channel separation at the output device.

The media format according to the invention can be made available so that it is compatible with the existing formats and the existing karaoke hardware. The discretely separated media format of the invention, however, with the content offered in accordance with the invention allows existing karaoke users to gain a considerably increased experience which would otherwise not be available to them.

In addition, however, the novel system expands the karaoke-style separation to a multitude of other applications. The novel system substantially departs from the conventional concepts and designs of the prior art. In so doing, the invention provides an apparatus primarily developed for the purpose of providing a means of addressing both the training and performance needs of a single or group of musicians, whether experienced or otherwise to enable them to play popular music either alone or in a limited public performance arena. Also, one and the same media carrier can now be used by a plurality of different performers or students, because the channel “elimination” can be freely controlled by the user. For example, if the “live” output of a given performer is deemed poor and/or unusable, the production director may opt to simply mute that stream and substitute with the backup audio stream from the DVD or other media or an alternative IP or other networked source.

The instrumental and vocal channelization permits, under certain selectable conditions, the playback of original artists' material to have one or more instruments to be muted therefore allowing another “substitute” performer to play their instrument instead. By way of example, a local band could contribute to the original artists' content by providing the drums, bass guitar, and vocals but continue to use lead guitar and backing singers.

Because the channelization is instrument-dedicated, the system may additionally permit the multiplexing of various audio streams from multiple sources whether local or remote. Therefore, an internet-based broadband karaoke system is highly achievable using the media format described herein. To this effect, a multi-contributor and or individual “American Idol”-style talent show may be created in which geographically remote artists and performers are utilized.

It should be understood that the method of channelization described herein is not limited in any way or fixed to exactly the described implementation. The basic concepts of the invention enable the use of any encoding system already in existence or still to be developed within the framework as described.

In this respect, before describing at least one embodiment of the invention in detail, it is to be understood that the invention is not limited in its application to the media choices so described and currently available and as described in the descriptions and drawings that follow. The invention is capable of other embodiments and of being practiced and carried out in various ways. In addition, one should understand that the phraseology and terminology employed herein are for the purpose of the description and one should not regard the terminology as limiting.

A variety of objects and advantages are associated with the invention:
A primary object of the present invention is to provide a vastly improved karaoke system, i.e., a new form of karaoke previously not available as a means of entertainment performance and education and training.
An object of the present invention is to allow all musicians to use the novel system, whether they be vocalists or instrumentalists.
The use of novel and digitally improved media renders it possible for all musicians to view the music score on-screen in a format that is comfortable to them. As Karaoke displays words, the system displays the music notes in a format that matches the instrument(s) being played, sheet music, tablature, and chords, for example.
It is a further object to provide for a type of group karaoke experience where several musicians can participate in the karaoke experience simultaneously and in conjunction with selected vocal and instrumental content from the original artists.
It is another object to enable a broadband karaoke experience where the performers are at differing locations. This will allow the stars (original artists) to perform live with groups of karaoke artists at different and multiple locations worldwide and simultaneously using a network, such as the Internet and computer networks to communicate their specific channeled, instrumental content. The individual audio streams are filtered, multiplexed, adjusted, and amplified at various performance points (“venues”) throughout the world whether public or private.
It is another object of the invention to provide a format for the distribution of licensed content as well as public domain content within the novel media. The content carried by the media will come from individual artists and from the major labels and feature the most popular music, drama, speeches, etc. from many different eras.
While at present DVDs and compact discs utilizing original artists content have limited licensing use in a public arena, as they are for home use only, the invention allows this to be opened up and lead to specific licensing through which the media according to the invention can be used for limited public use. This potentially generates revenue for the performers (live and dead) and the owners of the content in a manner that has not previously made available.

Other features which are considered as characteristic for the invention are set forth in the appended claims.

Although the invention is illustrated and described herein as embodied in a multi-channel audio/video system and authoring standard, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic view of a prior art Dolby® 5.1 surround sound system;

FIG. 2 is a simplified diagrammatic view of a mixer in accordance with the invention for use in such a Dolby® surround sound system;

FIG. 3 is a diagrammatic view of a GUI (graphical user interface) of a mixer according to invention;

FIG. 4 is a diagrammatic flow chart showing the process of creating media with multi-channel selectable content;

FIG. 5 is an exemplary display showing synchronized tablature, music video, and sheet music on a video display device; and

FIG. 6 is a simple diagram illustrating a hierarchical menu tree structure in an exemplary implementation.

### DETAILED DESCRIPTION OF THE PREFERRED EMBODIMENTS

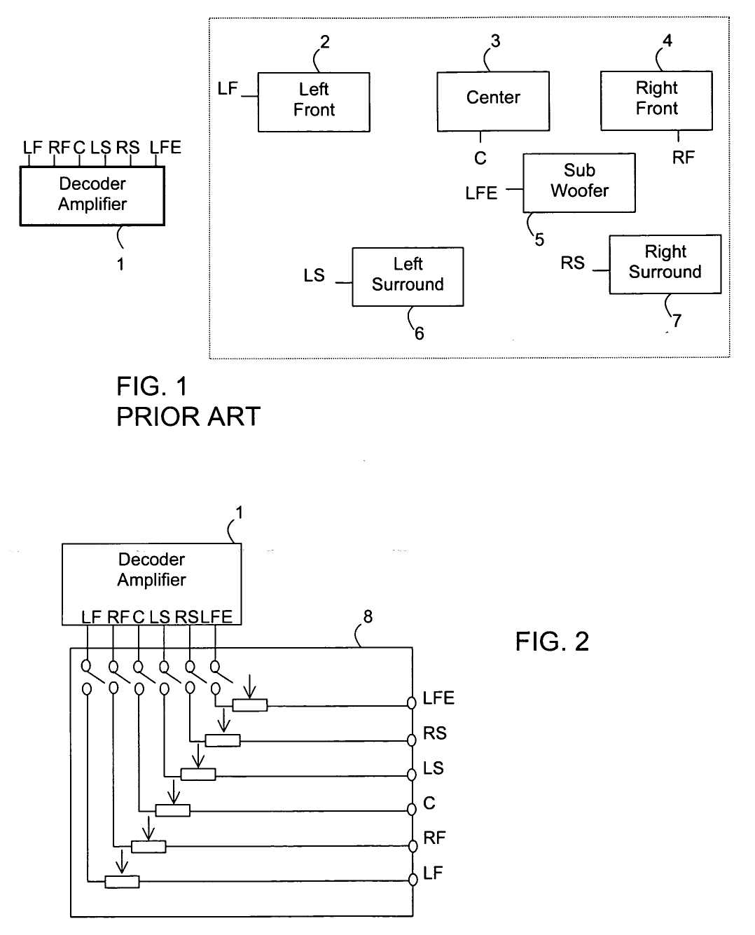

Referring now to the figures of the drawing in detail and first, particularly, to FIG. 1 thereof, there is shown a prior art surround sound system. A decoder and amplifier 1 is configured to “translate” the information carried on input channels (e.g., from DVD, TV, cable, satellite) into an output distribution to various speakers. The speakers include a left speaker 2, a center speaker 3, a right speaker 4. These carry the mid and high frequencies. A subwoofer 5 covers the low frequencies, or bass frequencies. In the Dolby® system, the subwoofer channel is referred to as the low frequency effects (LFE) channel. As bass frequencies are only marginally perceived by the human ear with directional qualities, a single bass speaker or subwoofer 5 is typically sufficient. The high and mid frequencies are also carried on a rear left speaker, or left surround speaker 6, and on a rear right speaker, or right surround speaker 7. The decoder sends the decoded signals to individual amplifiers, all within the decoder/amplifier 1, from where the amplified signals are transmitted to the various speakers 2, 3, 4, 6, and 7. The subwoofer signal carrying the LFE channel is typically only pre-amplified, as the subwoofer 5 has its own amplifier. If the speakers are connected by wireless signal transfer, of course, they are individually amplified at the speaker side.

If the input signal is coded for stereo, the output is routed with a substantially mirror-symmetric distribution to the front speakers 2, 3, 4 and, optionally, to the rear speakers 6, 7. The bass frequencies are output to the subwoofer 5. If the input signal is coded for Dolby 5.1 (or 6.1, or 7.1, for that matter), the output signals are separated in accordance with the given distribution code. In a home theater setting, for example, the primary audio is carried on the front speakers and on the subwoofer 5. The effects audio is strategically distributed to all of the speakers, including the surround speakers 6, 7.

It is most important to note in the context of the invention that the various channels of the modern surround sound system are entirely separate, i.e., discrete, non-matrixed. The primary systems that are most suited for the invention are the above-described Dolby® Digital 5.1 and DTS® (Digital Theater Systems. DTS is a similar surround system, with six entirely discrete channels, namely the front left, right, and center, the rear left and right, and the low-frequency channel. Variations of these discrete multi-channel systems are already starting to appear in the market and the invention, as will be understood from the following, is not limited to either of these systems. All that is required is a multi-channel system with discrete or substantially discrete channel separation.

The invention, in its most simplistic embodiment, is illustrated in FIG. 2. There, each of the separate output channels from the decoder/amplifier is routed through a mixer 8. The mixer 8 contains an on/off switch 9 and a potentiometer 10 for each channel. Each of the various outputs, i.e., connections to the speakers 2-7, can be selectively turned on and off via the switches 9 and the signal intensity can be controlled with the potentiometer 10. The mixer 8 can be implemented as a separate or integrated hardware component, or it can be implemented as a software component.

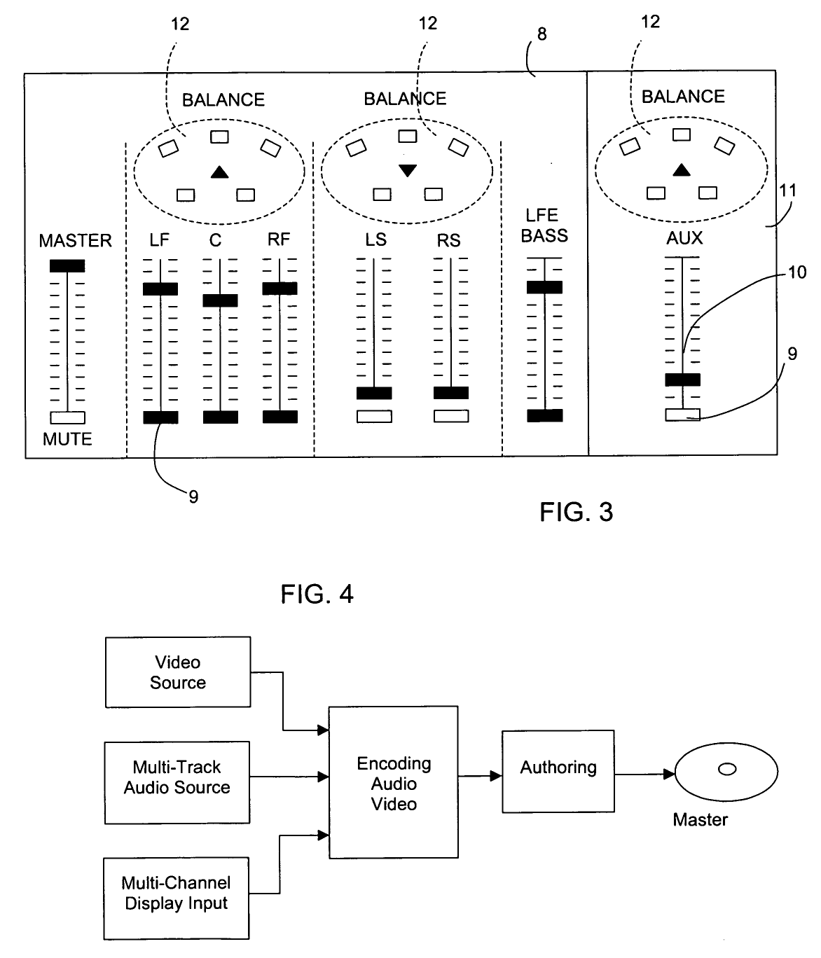

An exemplary GUI (graphical user interface) image of a mixer 8 is illustrated in FIG. 3. Again, six channels LF, C, RF, LS, RS, and LFE are separately controlled with corresponding toggle switches 9 and sliders 10. In addition, a master control is provided, as well as an auxiliary input control 11 with a slider 10 and an on/off toggle switch 9. Each group of inputs, namely the front/center speaker group, the rear speaker group, and the auxiliary input 11 also have a balance control 12. This allows the user to place any of the channels in any physical audio location that is available by the distribution of speakers.

It will be understood, in this context, that the typical surround sound distribution no longer applies in most instances of the present invention. In a surround sound setting, the front speakers are most heavily weighted, with the center speaker carrying much of the primary audio content and the left and right front speakers carrying the audio content similar to a regular stereo distribution. Also, the channel separation between the front speaker set is not very pronounced and there is considerable cross-talk between the channels. The rear speakers carry only very limited amounts of the primary audio and they are generally used only for effects. The LFE channel, of course, carries only low frequency audio information, typically in the range from 50 to 200 Hz. In the system according to the invention, on the other hand, the various channels and the speakers are in general equally weighted and the channel separation—at least on the input side and in the mixer—is maintained to a very high degree. That is, the channels are equally important, at least those channels that are coded for elimination. An example best underscores this point:

Assume the media carrier contains a selection of popular songs by various four-member rock bands, and it is coded for elimination of the voice track, the lead guitar track, and the bass track. On decoding the media in a Dolby® Digital system, the voice, the lead guitar, and the bass would be carried on separate channels with discrete separation between them. The other audio content could be distributed among the remaining channels. In the Dolby 6.1 and 7.1, the additional audio would also be matrixed over several channels. The user then chooses which of the channels to eliminate or turn down (or isolate, for that matter, and eliminate all the other channels—a great learning tool), so that he may replace the missing channel with his own contribution. This, of course, is similar in concept to Karaoke, yet with more freedom of selection and with vastly improved channel separation. On the output side of the mixer 8, the individual channels may once more be balanced with recognizable crosstalk or the output may be provided as a simple stereo stream (fed to two, three, or six speakers).

This, then, summarizes a first application of the invention. The system, even in its very simplistic implementation in the mixer 8, addresses the needs of musicians, even groups of musicians, or audiences, whether experienced musicians or otherwise, to enable them to play and listen to (popular) music with a view towards entertaining themselves or others or for the purpose of learning and training. An aspiring guitarist, for example, may turn off or at least turn down the guitar track of a recording, and try to play along with the remaining tracks. Conversely, he may eliminate all of the other tracks and listen only to the selected guitar track. Or, another instrumentalist may turn off the voice track of a recording and substitute his own solo.

While we describe herein primarily popular music applications, the invention has a much wider range of application, such as, for example, in voice sequenced training environments, theatrical plays, etc. For example, the lead role or supporting role in a play may be selectively eliminated (or isolated, i.e., the supporting cast and/or the orchestra can be turned off or down, so that only the featured “solo” would be heard) and then replaced or emulated by the aspiring artist.

It is also possible to encode several tracks onto a given channel. For example, in a big band recording with several solos (e.g., 12 bars trumpet solo followed by 12 bars saxophone solo, followed by 12 bars trombone solo), one channel could carry each of the solos in sequence. An aspiring artist could then “replace” the solo with any instrument of his choosing through the entire 36 bars. The remaining instruments of the big band would be decoded for audio output on all six speakers, on only five speakers, or onto a stereo system. That is, of course, it is not necessary that the decoded (and augmented) content be output through a discrete/digital system. It may also be output through a regular stereo or monaural system.

The novel system, of course, requires appropriately encoded media. One of the keys to the novel system is the unique format of the media used for audio/video playback and its interactivity. As previously noted, prior art Karaoke requires the use of specific Karaoke hardware and is severely limited in performance being restricted solely to the addition or elimination of the vocal content only in a piece of music.

Sufficient data density and storage capacity is provided by the DVD format. The DVD-Video specification provided by the inventors allows the disks to be played using a conventional DVD Player, A/V amplifier, and television set with remote control. These components represent a surround sound investment that consumers have already made; it is thus a hardware platform that we plan to fully utilize. Utilizing existing surround sound hardware obviates the need to purchase additional hardware. There is no need to purchase specific additional karaoke hardware. That is, we supply software content that takes full advantage of an emerging audio/video platform rather than forcing consumers and musicians to accept another proprietary platform or an evolutionary karaoke platform.

DVD has been available since 1997 and already new formats with yet more capacity are being developed and are due to become available by about 2006. We intend to migrate existing (archived) content and additionally develop new content using these higher capacity discs when they become available. Increased capacity is needed in USA and Japan to meet the requirements for HDTV, which is already available via cable, satellite and from broadband companies in these markets. DVD's improved quality compared with NTSC, will not compare with HDTV at up to 1080 lines and it is believed that consumers will want similar quality for pre-recorded movies and for the public performance of the novel media according to the invention. We not only take advantage of the increased space for video content but will also utilize this for increased multi-channel audio content and on-disc operational software which will be required for the more intricate implementations of the invention. The higher-density media allow us to include the rendering of 3D-like quality pictures. Performers can therefore be created, using 3D scanning techniques, and emulated on screen bringing together virtual artists from around the world and simulating them together on a virtual stage. These features become available through the implementation of interactive elements that are currently envisioned by us.

As the data content is increased, primarily to include HDTV programming and high-resolution audio programming, suitable recordable optical disc formats are also needed. There are two different formats being developed, namely, Blu-ray Disc and HD-DVD both using a blue laser for reading and writing data.

The Blu-ray format provides for discs that offer a capacity of 25 GB per layer. This is achieved by the use of a blue laser at 405 nm wavelength, an increase in numerical aperture to 0.85 and a reduction in the cover layer from 0.6 mm for DVD to 0.1 mm. The HD DVD-ROM disc has a capacity of 15 GB per layer per side, offering capacities up to 30 GB per side or 60 GB per disc. These can be used for distributing HD movies. HD DVD-RW discs are re-writable and can be used to record 20 GB per side for re-writable versions. HD DVD-R discs are write-once recordable discs with a capacity of 15 GB per side.

The DVD-Video format does not take the Internet into account; nor do standard PC or set-top DVD-Video players. With eDVD, both the players and the content are enhanced to take advantage of Internet connectivity. eDVD content can be accessed using an Internet-enabled DVD player.

There are currently two types of eDVD players—PC-based and set-top based eDVD players—each take advantage of a set of JavaScript extensions to standard and embedded (for set-top) web browsers called ITX. The ITX extensions, (created by InterActual Incorporated) are being adopted by Hollywood studios and consumer electronics companies worldwide, and define a standard language by which DVD players and browsers can communicate that has quickly become the industry standard.

On the personal computer, many different software and hardware-based DVD players from different manufacturers are installed on hundreds of millions of PCs. To enable these regular players to be used as eDVD players, a special eDVD run-time engine is installed on the PC from the eDVD video title. This run-time engine acts as a universal interpreter between the DVD player engine and the Web, extending the functionality of the standard software DVD player. Presenting both the DVD-Video portion and the web content in the same interface, the eDVD run-time player delivers the user a single, streamlined experience. The eDVD run-time player will be distributed with eDVD titles according to the invention, so no matter what type of DVD player the user has on his PC, as long as there is an Internet connection, the eDVD title will play back. On the set-top, player manufacturers are now implementing the ITX specification to ensure compatibility with eDVD titles. Web-connected DVD players are now becoming available, which should obviate the need for the use of personal computers to access this interactive content.

DVD-Video titles according to the invention can be created as eDVD titles at any point in the DVD-video authoring process. Normally, our content developers will enhance the media with eDVD extensions and run-times, during the production process but the eDVD content will also be added once a DVD-Video title is published. For advanced eDVD titles, it is possible to program web-site development applications to enable placement of a DVD-Video window inside the web page and then create links that allow the DVD-Video to be controlled from any web button or event. These windows may also show as an example remote performers performing live through a webcam or other steaming video link.

Such eDVD links embedded in the data content may also provide cross-platform links to other related web sites, (for example event sponsors), PDFs, (for example, accessing printable music and lyric information relating to a particular song) and image files (for example, pictures of original artists, discount vouchers, etc). This enhanced content may either be embedded in the eDVD or provide links enabling this to be sourced externally. It should be understood that all of the added embedded content or hyperlinks are implemented through the DVD authoring process.

In addition, the novel media may also include ‘links’ enabling users/artists to connect to each other through dedicated internet protocol connections via web pages. These web pages provide live streaming video and audio in numerous formats including real media (.ra) and windows media 9/10 (.wm) file formats, DlVx and others. The links are preferably positioned in the fixed content made available on the eDVD. Additional links may also be made available in the resources section of the DVD so as to provide the user the opportunity to download notes, sheet music and access other web resources pertinent to the content made available on the disk itself. These may include artists' bios, downloadable plug-ins which will enable other resources to be accessed and played back. By way of example, these may include links to a free download site for Adobe® Acrobat Reader, a free piece of software that may be required to print certain sheet music, and DIVx codec required for viewing DIVx compressed video and an appropriate eDVD run time engine.

It goes without saying that all eDVD media and eDVD links have no effect on the compatibility of the existing DVD-Video portion of the DVD title and will therefore be designed to be backwardly compatible with existing non-eDVD players.

According to the invention, the novel format utilizes most of the specifications of prior-art DVD players to create the media format. This permits the user of the media to be able to use the DVD-video media in two ways. Providing a dual use standard enables the media format to gain considerable consumer penetration and obviating the need to provide dual formats to address the separate needs of the domestic and professional karaoke performer.

In a more “professional” embodiment of the invention, the original content owners, such as publishers, provide the original media to a media creator who will arrange with the recording studios (i.e. copyright owners) to digitally re-master the original contents of a given recording. The individual instruments are thereby digitally recorded and strategically distributed and assigned to its own respective channel number. In the Dolby® 5.1 and the DTS systems, for example, six channels are created representing the major instruments used. They are then digitally encoded using Dolby 5.1 or DTS. The decoder/amplifier 1 then decodes the data stream and distributes the outputs accordingly. On use, the aspiring performer may then turn off or turn down any of the channels and “replace” the missing channel with his or her own distribution.

The instrument-to-channel assignment is designated on the DVD cover sleeve and on the menu. The assignment can be freely varied, depending on the artist or the type of audio content (e.g., large orchestra, small band, drama).

The seventh input 11 into the audio mixer 8 allows the user to connect his own component, such as a microphone amp output, a guitar amp output, or the like. It will be understood that the additional input 11 may be a plurality of further inputs, depending on the complexity of the user's system. The mixer 8 (whether it be a hardware box, a software implementation, or a mixed system) allows the relative output volumes to be adjusted and balanced.

For domestic use, the components required are DVD player (with or without Dolby 5.1) and TV or home theater components if available with no repositioning of the speakers required. The user would select “Domestic” mode from the menu displayed on-screen and the output decoder would default to “stereo” output ensuring all instruments are channeled through the front two or three speakers only. In this mode, all the channels are multiplexed into a stereo mode and no adjustment can be made to the volume levels of each of the instruments. The volume levels of each instrument would be at the default level created by the content provider during the digital mastering process at the recording studio. The performer would use his own instrument, amplifier, microphone, and other required devices with this audio arrangement and use these in conjunction with the above-described setup.

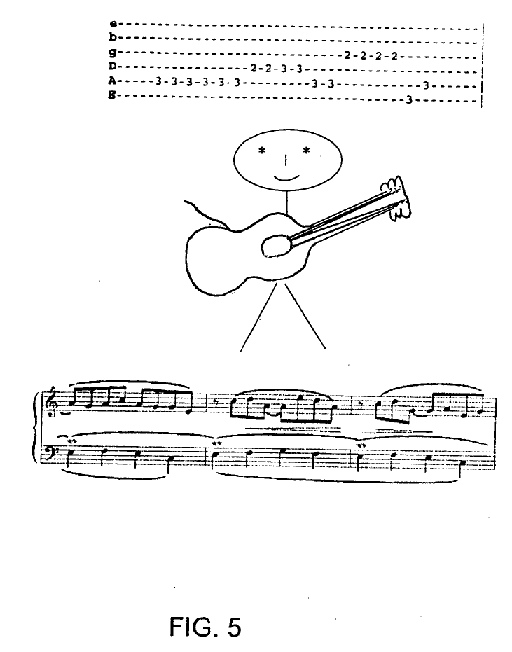

Referring now to FIG. 4, the video and audio creation process is as follows. Several production activities are coordinated, where video footage of the artist is combined with on-screen graphics in various formats depicting various music notation styles. These are customized according to the track specification itself, the artist concerned and the instrument being played or omitted. For example, sheet music is displayed where the instrument being played is the piano. In the case of lead guitar, the music displayed is in tablature and displayed below the moving video. A combination, and a dual display may also be provided. An exemplary display is shown in FIG. 5.

The video production is an important key to the product as it creates the onscreen material that the performer uses in order to play and perform in time with the music being played. As in the prior art, the sheet music and lyric being displayed may be time-coded and highlighted and it will thus aid the performer to in keeping with the timing. This, of course, is fully synchronized with the audio being played. Also, with the added data capacity available on the DVD or flash media, it is also possible to record a considerable amount of related video content (e.g., an entire book of sheet music related the audio content, lyrics, background information, etc.) and also to make the display freely selectable. Say, for example, that the audio content is comprised of chamber orchestra music. The accompanying sheet music would then include the violins, the viola, the cello, and the keyboard. Upon selection by the user for the “elimination” of the first violin, for example, a further video choice may appear that allows the user to only display the sheet music for the first violin. The violinist, i.e., the user, would then be able to play along with the other instruments and read along with sheet music.

In a preferred embodiment, the video streams are created as DVD assets in MPEG2 (.mpv file type) and are connected to each other as scenes linked together at chapter points in the menus during the authoring stage of the process. The audio and video streams are typically acquired and edited under license from content providers (record “labels”, film studios and artists) and sandwiched with novel material either created by us or licensed from other vendors/partners, including sheet music producers, etc.

In a preferred embodiment, the audio and video digital assets are encoded in MPEG-2 and Dolby Digital 5.1. The sources may have originated in other formats but will be converted during this phase.

During the authoring process, the MPEG-2 and Dolby Digital 5.1 assets are combined to form a program stream. The DVD compilation is then made and includes a continuous audio track recorded in Dolby Digital 5.1 with our instrument encoding and with multiple chapter points denoting each song and subsets of these songs. The song subsets include the following and will vary depending on the song in question.

This is the recording and production stage of the DVD compilation, and results in the making of the master disk, which will then be duplicated for production. The disk is recorded in the DVD-R format to ensure that the media will play in older DVD players with or without an integrated Dolby 5.1 encoder.

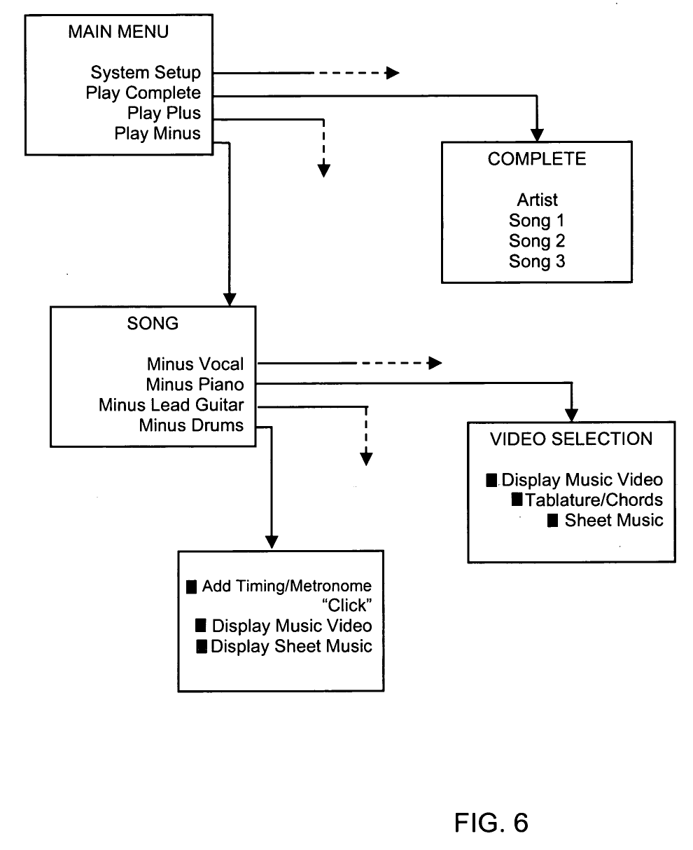

In one embodiment of the invention, a main menu layout may have the command tree structure as illustrated in FIG. 6.

The concept described herein lends itself well to implementation on a network (i.e., Internet) platform. In this way, an opportunity is opened up to permit the novel system to be shared by many remotely through a network interface. The World Wide Web interface will be hosted at www.starsessions.com.

Due to the bandwidth constraints, it is at this time advisable to employ audio streams in the smaller accepted formats whether compressed or otherwise and allow the fusing of these through our virtual mixer. Prior art-type karaoke only allows the replacement of the vocals and does not use original content. Our novel system, on the other hand, uses music from the original artists and will also facilitate the participation of these artists themselves. Actual recording stars may engage with multiple groups, whether domestic or public and create a unique instrumental karaoke experience. Any of a wide variety of electronic media file formats may be employed, such as, for example, MP3, Windows® Media, Real® Audio, and MP4 (MPEG-4/AAC).

In some respects, the instantly described invention is a development of the original Karaoke concept. As such, the invention utilizes the considerable amount of karaoke hardware that has already been distributed. Care must thus be taken to render the system backwards compatible with at least some of the available formats. As far as understood, nine file formats have been most commonly used, of which the most popular are the following:
CD+G The most popular “non-computer” karaoke format. Used by professional DJ's and KJ's. These are standard audio CD's with additional graphic commands in the normally unused “subcode” area. Graphics are interpreted by the player as the audio is played to display and highlight the lyrics or display simple logos or images.
VideoCD Also known as VCD or Digital Video Disc. A popular form of Karaoke in Japan, VCD's are similar to CD-ROM discs and contain a file system in which each track is a file. VCD's use MPEG video and audio to display lyrics on top of a video picture.
MIDI A standard format used by many musical instruments and devices. The most popular computer Karaoke format. Midi files contain events, but not actual content. The layback device generates the music. Karaoke MIDI files use text events to synchronize the lyrics to the music.
MP3+G The “new” PC Karaoke standard. MP3+G files are created by “ripping” the data from a standard CD+G disc. The audio is compressed using the very popular MP3 format to save space. The graphics are standard CD+G graphics data in an uncompressed format.

As noted above, traditional karaoke enables the “removal” of the voice track only. The system presented herein enables the removal or isolation of any of a plurality of tracks. In order for the traditionally existing hardware to be used then, the file format according to the invention maintains complete or virtually complete channel separation.

Referring once more to FIG. 5, an exemplary media carrier may be entitled “Elton John's Greatest Hits for Piano.” The tracks in this case are laid down in CD+G format and include playback options to include “All,” “minus vocals,” and “minus piano.” In some cases, which are particularly suited for educational purposes, it is also possible to isolate one track with a setting selection “minus piano, minus accompaniment—voice only.” The same applies to the graphics or video display content, with the selections including options to display a music video, printed lyrics, or the music score. All of these, of course, are synchronized to the music.

1. A multi-channel multimedia format, comprising:
a first digital channel carrying at least a first track of audio content of a given performance;
a second digital channel carrying a second track of audio content of the given performance in synchronicity with said first track; and
a third channel carrying video content related to the given performance and synchronized to said first and second tracks of audio content; and
wherein each of said first, second, and third channels is separately and independently selectable to be played through an output device.

2. The multimedia format according to claim 1, wherein said first and second channels are commonly encoded and, upon decoding, carry discretely separate tracks of the given performance and are separately playable through a first speaker and a second speaker, respectively.

3. The multimedia format according to claim 1, wherein said third channel carries video content selected from the group consisting of a music video, lyrics, tabular music, and sheet music.

4. The multimedia format according to claim 1, wherein said first and second channels are two of at least five discrete digital channels.

5. The multimedia format according to claim 4, wherein said discrete digital channels are coded in a Dolby® Digital system or a DTS® system.

6. A digital media carrier for advanced karaoke, comprising:
audio content encoded in at least five discrete digital channels of a Dolby® or a DTS® system;
said at least five discrete digital channels containing up to five solo channels, each featuring individual tracks of an audio performance, and each being individually selectable and deselectable; and
a video channel featuring video display content related to the audio performance for display on a visual display.

7. The digital media carrier according to claim 6, wherein each of said five solo channels is playable through a different speaker of the Dolby® or DTS® system, and an LFE channel is configured to multiplex up to five of said solo channels and to be played through headphones connected to the Dolby® or DTS® system.

8. The digital media carrier according to claim 6, wherein said video channel carries video content selected from the group consisting of lyrics, music video, music notation, tablature, and individual instrument sheet music, and said video content is synchronized with audio content.

9. A computer-readable medium having mutimedia content stored thereon, comprising:
audio content in an encoded format to be decoded into discrete channels for audio playback with a menu-driven option of selective elimination from the audio playback of at least one of the discrete channels; and
video content synchronized to said audio content for display on a video display during the audio playback.

10. A karaoke system, comprising:
a player for reading and processing the computer-readable medium according to claim 9;
a mixer for selecting/deselecting and adjusting a volume of each audio channel of the audio content;
at least one audio amplifier connected to said player for playing back decoded audio content;
at least one audio playback device (speaker, headphone, recorder) connected to said audio amplifier; and
a video display for displaying the video content carried on the computer-readable medium.

11. A computer-readable medium having stored thereon a data structure comprising:
a first channel of audio content in an encoded format to be decoded into a plurality of discrete channels for audio playback with a menu-driven option of selective elimination from the audio playback of at least one of the discrete channels; and
a second channel of video content synchronized to said audio content for display on a video display during the audio playback.
